(19) United States
(12) Patent Application Publication
(10) Pub. No.: US 2008/0150835 A1
(43) Pub. Date: Jun. 26, 2008

(54) PLASMA DISPLAY APPARATUS AND DRIVING METHOD THEREOF

(75) Inventors: Dongki PAIK, Yongin-si (KR); Jongrae Lim, Anyang-si (KR); Tae Heon Kim, Seoul (KR); Wootae Kim, Yongin-si (KR); Sung Chun Choi, Anyang-si (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 11/613,372

(22) Filed: Dec. 20, 2006

(51) Int. Cl. H05H 1/00; G09G 3/28

(52) U.S. Cl. 345/60; 345/68; 315/169.4

(57) ABSTRACT

Disclosed are a plasma display apparatus and a driving method thereof. The plasma display apparatus includes a plasma display panel comprising a plurality of scan electrodes and sustain electrodes, a driver driving the plurality of scan electrodes and sustain electrodes, and a negative sustain pulse controller controlling the driver and adjusting each of an energy supply time and an energy recovery time of a negative sustain pulse supplied to one or more of the scan electrodes or sustain electrodes during a sustain period.

### BACKGROUND

1. Field

The present invention relates to plasma display apparatus and driving method thereof.

2. Description

A plasma display panel generally comprises a front panel and a rear panel. Barrier ribs formed between the front panel and the rear panel form discharge cells. Each of the discharge cells is filled with an inert gas containing a main discharge gas such as neon (Ne), helium (He) or a Ne—He gas mixture and a small amount of xenon (Xe). A discharge generated by a high frequency voltage causes the inert gas to emit vacuum ultra violet rays, which in turn excite a phosphor provided between barrier ribs, to thereby implement images. Since the plasma display panel can be manufactured to be thin and light, the plasma display panel has been considered as a next generation display apparatus.

FIG. 1 is a view illustrating a structure of a general plasma display panel.

Referring to FIG. 1, the plasma display panel comprises a front panel 100 and a rear panel 110 which are coupled in parallel to be spaced from each other at a given distance therebetween. The front panel 100 comprises a front glass 101 being a display surface on which images are displayed, and the rear panel 110 comprises a rear glass 111 being a rear surface. Scan electrodes 102 and sustain electrodes 103 are formed in pairs on the front glass 101 to form a plurality of maintenance electrode pairs. A plurality of address electrodes 113 are arranged on the rear glass 111 to intersect the plurality of maintenance electrode pairs.

The front panel 100 comprises the scan electrode 102 and the sustain electrode 103, each comprising transparent electrodes (a) made of a transparent indium-tin-oxide (ITO) material and bus electrodes (b) made of a metal material. The scan electrode 102 and the sustain electrode 103 generate a mutual discharge therebetween in one discharge cell and maintain light-emission of the cell. The scan electrode 102 and the sustain electrode 103 are covered with one or more upper dielectric layers 104 for limiting a discharge current and providing insulation between the maintenance electrode pairs. A protective layer 105 with a deposit of MgO is formed on an upper surface of the upper dielectric layer 104 to facilitate discharge conditions.

A plurality of stripe-type (or well-type) barrier ribs 112 are formed in parallel on the rear panel 110 to form a plurality of discharge spaces, that is, a plurality of discharge cells. In addition, the plurality of address electrodes 113 are arranged in parallel with the barrier ribs 112 to perform an address discharge to thereby cause the inert gas in the discharge cells to generate vacuum ultraviolet rays. On the upper surface of the rear panel 110 there are applied a red (R), a green (G), and a blue (B) phosphors to emits visible light for displaying images when a sustain discharge occurs. A lower dielectric layer 115 is formed between the address electrodes 113 and the phosphors 114 to protect the address electrodes 113.

The plasma display panel of this structure comprises a plurality of discharge cells formed in a matrix form and is driven by a driver having a driving circuit for supplying prescribed pulses to the discharge cells. A combination of these plasma display panel and driver is shown in FIG. 2.

FIG. 2 is a view illustrating a combination of a plasma display panel and a driver.

Referring to FIG. 2, the driver, e.g. comprises a data driver 201, a scan driver 202, and a sustain driver 203. These drivers 201, 202, 203 are connected with the plasma display panel 200.

The plasma display panel 200 is supplied with data pulses from the data driver 201. In addition, the plasma display panel 200 receives scan pulses and sustain pulses outputted from the scan driver 202 and sustain pulses outputted from the sustain driver 203. A discharge occurs at the cells selected by the scan pulses among a number of cells provided on the plasma display panel 200. The discharge causes light to be emitted at the selected cells. The data driver 201, scan driver 202, and sustain driver 203 each are connected to address electrodes X1˜Xm, scan electrodes Y1˜Yn, and sustain electrodes Z1˜Zn of the plasma display panel 200 through a connection member such as a FPC (Flexible Printed Circuit) (not shown).

A method of implementing image gray scale at this plasma display apparatus is shown in FIG. 3.

FIG. 3 is a view illustrating a method of implementing image gray scale.

Referring to FIG. 3, a method of implementing gray scale in a plasma display apparatus separates a frame into a number of sub-fields each of which has the different number of light emission, and again separates each sub-field into a reset period RPD for initializing all the cells, an address period APD for selecting the cell to be discharged, and a sustain period SPD for implementing gray scale according to the number of discharges. For example, in case of displaying an image with 256 gray scale, a frame period (16.67 ms) corresponding to 1/60 sec is divided into, e.g., 8 sub-fields SF1 to SF8 as shown in FIG. 3, and each of the sub-fields SF1 to SF8 is again divided into a reset period, an address period and a sustain period.

Here, the reset period and address period of each sub-field is the same with respect to each sub-field. An address discharge for selecting cells where a sustain discharge occurs by a voltage difference between an address electrode and a scan electrode. Each sustain period increases at each sub-field at the rate of 2ⁿ (where, n=0, 1, 2, 3, 4, 5, 6, 7). As such, image gray scale is represented by adjusting the sustain period of each sub-field, i.e. the number of sustain discharges because sustain periods are varied at each sub-field. Driving waveforms of a sub-field are shown at FIG. 4 in the method of driving a plasma display panel driven according to this image gray scale implementation method.

FIG. 4 is a view illustrating driving waveforms according to a driving method of a plasma display panel.

Referring to FIG. 4, the plasma display panel is driven with a sub-field divided into a reset period for initializing all the cells, an address period for selecting cells where a sustain discharge occurs, a sustain period for maintaining the discharge of the selected cells, and an erase period for erasing wall charges within the discharged cells.

In the set up period of the reset period, all the scan electrodes are simultaneously applied with a rising ramp waveform Ramp-up. A weak dark discharge occurs within the discharge cells of the entire screen by this rising ramp waveform. Due to this set up discharge, positive wall charges are accumulated on the address electrodes and sustain electrodes and negative wall charges are accumulated on the scan electrodes.

A falling ramp waveform Ramp-down, which falls from a positive voltage being lower than the peak voltage of the rising ramp waveform to a specific voltage level below ground GND level voltage in the set down period after the rising ramp waveform was supplied, causes a weak erase discharge in the cells thereby to sufficiently erase wall charges excessively formed in the scan electrodes. This set down discharge allows wall charges to be evenly distributed within the cells so that an address discharge can occur stably.

In the address period, negative scan pulses are sequentially applied to the scan electrodes, and at the same time positive data pulses synchronized with the scan pulses are applied to the address electrodes. The voltage difference between the scan pulse and data pulse is added to the wall voltage generated in the reset period, thereby causing an address discharge to occur in the discharge cells applied with the data pulses. The wall charges are generated in the cells selected by the address discharge as many as a discharge can occur when the sustain voltage Vs is applied. A positive voltage Vz is supplied to the sustain electrodes so that unwanted discharges with the scan electrodes do not occur during at least one of the set down period or address period by decreasing the voltage difference between the sustain electrodes and the scan electrodes.

In the sustain period, sustain pulses Sus are applied alternately to the scan electrodes and sustain electrodes. The wall voltage at the cells selected by the address discharge are added to the sustain pulses, thereby causing sustain discharges.

A voltage of an erase ramp waveform Ramp-ers having small pulse width and voltage level is supplied to the sustain electrodes in the erase period after the sustain discharge was completed, thereby erasing the wall charges residing within the discharge cells of the entire screen.

On the other hand, positive ions are accumulated on the address electrodes X each having a relatively lower potential difference, as positive (+) sustain pulses sus are alternately applied to the scan electrodes Y and sustain electrodes Z during a sustain period in the plasma display apparatus described above. At this time, the positive ions, which have greater mass than electrons, make ion bombardments to the phosphors (‘114’ in FIG. 1) of the rear panel on which address electrodes X are provided, which has lessened the life span of the plasma display apparatus.

A negative sustain driving method is illustrated in FIG. 5, which has been recently developed to reduce the loss of phosphors.

FIG. 5 is a view illustrating driving waveforms according to a negative sustain driving method of a plasma display panel.

Referring to FIG. 5 taken in conjunction with FIG. 1, a sustain pulse applied to scan electrodes Y and sustain electrodes Z provided on a front panel 100 during a sustain period is set to have a positive voltage level −Vs, so that electrons are relatively accumulated on a rear panel 110 on which address electrodes X are provided. Accordingly, ion bombardments made to phosphors 114 on the rear panel 110 can be reduced to thereby increase the life span of the plasma display apparatus.

In addition, the amount of ion bombardments made to a MgO layer 105 deposed on the front panel 100 is increased while positive ions are accumulated on the front panel 100, thereby improving the generation rate of secondary electrons. That is, there has been an advantage in that the life span of the plasma display apparatus can be increased and a discharge firing voltage can be decreased by preventing the loss of phosphors 114 while increasing the amount of generation of secondary electrons.

A sustain pulse applied during a sustain period among driving waveforms is shown at FIG. 6 in more detail.

FIG. 6 is a view illustrating a negative sustain pulse applied during a sustain period among driving waveforms according to a negative sustain driving method of a plasma display panel.

Referring to FIG. 6, negative sustain pulses are applied alternately to scan electrodes and sustain electrodes during a sustain period. At this time, one sustain pulse covers an energy supply time ER UP-Time from the application of a reference voltage GND to the arrival of a sustain voltage −Vs and an energy recovery time ER Down-Time from the sustain voltage −Vs to the return to the reference voltage GND by the recovery of energy. The sustain pulse has a prescribed slope during these energy supply time ER Up-Time and energy recovery time ER Down-Time. As an example, the plasma display panel of more than 40 inches has employed the energy supply time ER Up-Time and energy recovery time ER Down-Time having the widths W1, W2, each of which is more than 300 ns and less than 500 ns.

On the other hand, a long gap structure has been proposed in which the gap between a scan electrode and a sustain electrode is increased so that positive column zones can be utilized upon discharge to raise the driving efficiency of a plasma display panel. This will now be described with reference to FIG. 7.

FIG. 7 is a view illustrating discharge regions between electrodes of a plasma display panel.

Referring to FIG. 7, when a voltage is applied to each of a cathode and an anode provided, electrons are accelerated by electric fields toward the anode to collide with surrounding neutral particles. At this time, the neutral particles undergo an ionization process separating the neutral particles into positive ions and electrons or excitation process raising to a high level the energy of outmost shell electrons in a neutral gas. The ions acquired through the ionization process are also accelerated by electric fields toward the cathode to collide with the cathode, thereby releasing new electrons (secondary electron release).

The region where this discharge occurs can be separated into a negative glow zone and a positive column zone, the excitation process vigorously proceeds in the negative glow zone to thereby emit visible light and ultraviolet rays strongly. However, the negative glow zone has a lower emission efficiency than the positive column zone because most of these visible light and ultraviolet rays generated at the negative glow zone are consumed as heat energy. Therefore, a long gap structure has been used in which a gap between electrodes is set to be distant to be capable of utilizing a positive column zone having high emission efficiency.

A discharge firing voltage for occurring a sustain discharge increase according to the long gap structure since the gap between electrodes is set to be distant and thus capacitance becomes small. Therefore, there has existed a problem that it is difficult to lead to a sustain discharge with the sustain pulse shown in FIG. 6 as an example of a sustain pulse.

### SUMMARY OF THE DISCLOSURE

In one aspect, a plasma display apparatus comprises a plasma display panel comprising a plurality of scan electrodes and sustain electrodes, a driver driving the plurality of scan electrodes and sustain electrodes, and a negative sustain pulse controller controlling the driver and adjusting each of an energy supply time ER Up-Time and an energy recovery time ER Down-Time of a negative sustain pulse supplied to one or more of the scan electrodes or sustain electrodes during a sustain period.

The energy supply time ER Up-Time and the energy recovery time ER Down-Time of the negative sustain pulse supplied to one or more of the scan electrodes or sustain electrodes each may be less than 300 ns.

The energy supply time ER Up-Time and the energy recovery time ER Down-Time may be the same.

The energy recovery time ER Down-Time may be longer than the energy supply time ER Up-Time.

A gap between the scan electrode and the sustain electrode may be more than 100 μm.

The gap between the scan electrode and the sustain electrode may be more than 150 μm.

In another aspect, a driving method of a plasma display panel comprises a plurality of scan electrodes and sustain electrodes, wherein an energy supply time ER Up-Time and an energy recovery time ER Down-Time of a negative sustain pulse supplied to one or more of the scan electrodes or sustain electrodes during a sustain period of a plurality of sub-fields can be respectively adjusted.

The energy supply time ER Up-Time and the energy recovery time ER Down-Time of the negative sustain pulse supplied to one or more of the scan electrodes or sustain electrodes each may be less than 300 ns.

The energy supply time ER Up-Time and the energy recovery time ER Down-Time may be the same.

The energy recovery time ER Down-Time may be longer than the energy supply time ER Up-Time.

A gap between the scan electrode and the sustain electrode may be more than 100 μm.

The gap between the scan electrode and the sustain electrode may be more than 150 μm.

In still another aspect, a plasma display apparatus comprises a plasma display panel comprising a scan electrode, a sustain electrode, and a barrier rib, wherein the height of the barrier rib is less than a gap between the scan electrode and the sustain electrode, a driver driving the scan electrode and the sustain electrode, and a negative sustain pulse controller controlling the driver and adjusting each of an energy supply time and an energy recovery time of a negative sustain pulse supplied to one or more of the scan electrode or the sustain electrode during a sustain period.

The scan electrode and the sustain electrode each may include a transparent electrode, and the gap between the scan electrode and the sustain electrode may be substantially equal to a gap between the transparent electrode of the scan electrode and the transparent electrode of the sustain electrode.

A gap between the scan electrode and the sustain electrode may range from 100 μm to 400 μm.

A gap between the scan electrode and the sustain electrode may range from 150 μm to 350 μm.

### BRIEF DESCRIPTION OF THE DRAWINGS

FIG. 1 is a view illustrating a structure of a general plasma display panel;

FIG. 2 is a view illustrating a combination of a plasma display panel and a driver;

FIG. 3 is a view illustrating a method of implementing image gray scale of a plasma display panel;

FIG. 4 is a view illustrating driving waveforms according to a driving method of a plasma display panel;

FIG. 5 is a view illustrating driving waveforms according to a negative sustain driving method of a plasma display panel;

FIG. 6 is a view illustrating a negative sustain pulse applied during a sustain period among driving waveforms according to a negative sustain driving method of a plasma display panel;

FIG. 7 is a view illustrating discharge regions between electrodes of a plasma display panel;

FIG. 8 is a view for illustrating a structure of a plasma display apparatus according to an embodiment of the present invention;

FIG. 9 is a view illustrating an example of driving waveforms according to an embodiment of a negative sustain driving method of a plasma display panel of the present invention;

FIG. 10 is a view illustrating a negative sustain pulse applied during a sustain period among driving waveforms according to the embodiment of a negative sustain driving method of a plasma display panel of the present invention; and

FIG. 11 illustrates a plasma display panel of a plasma display apparatus according to the present invention.

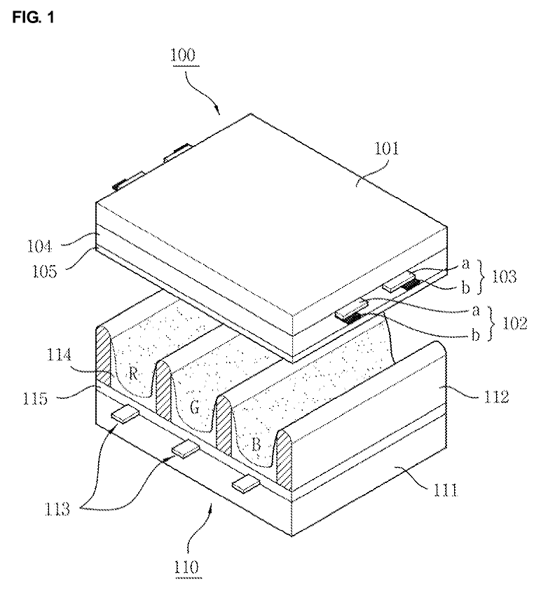

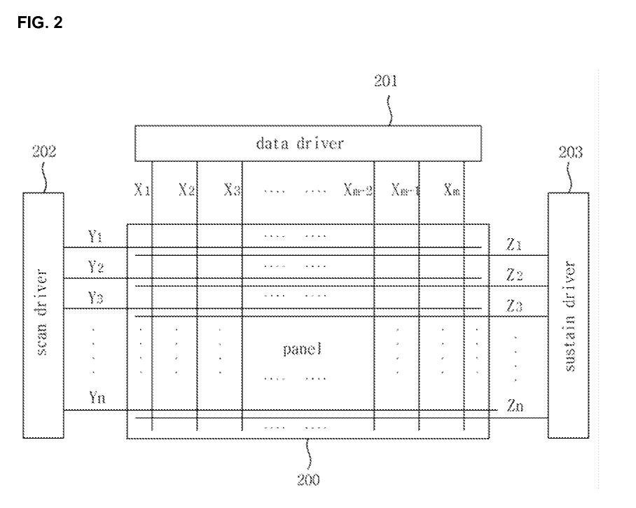

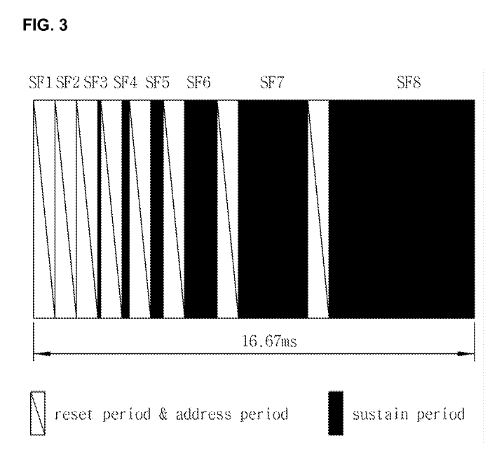

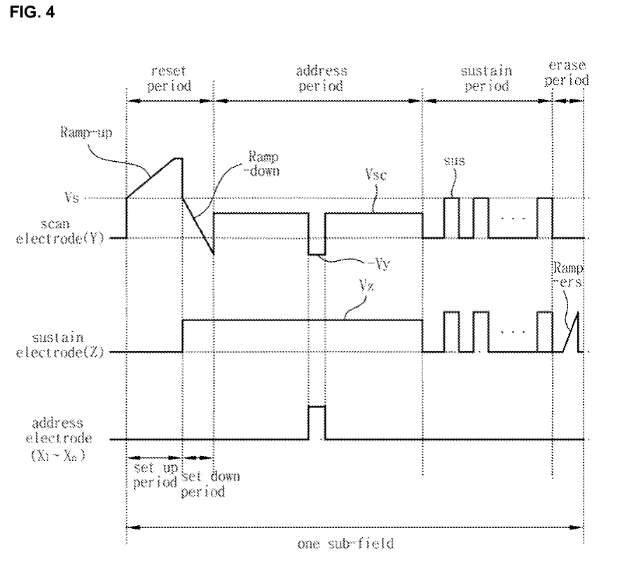

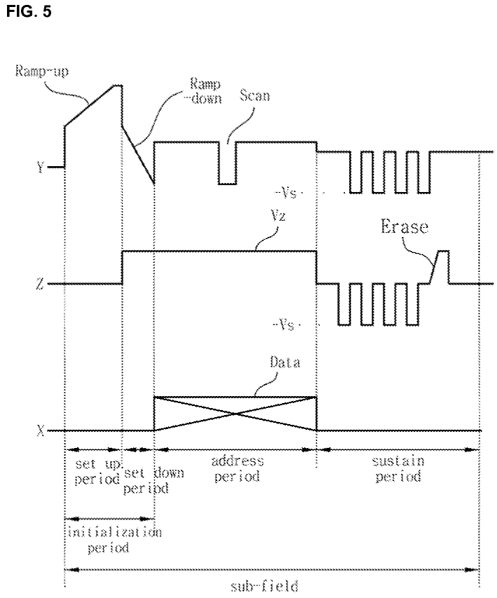

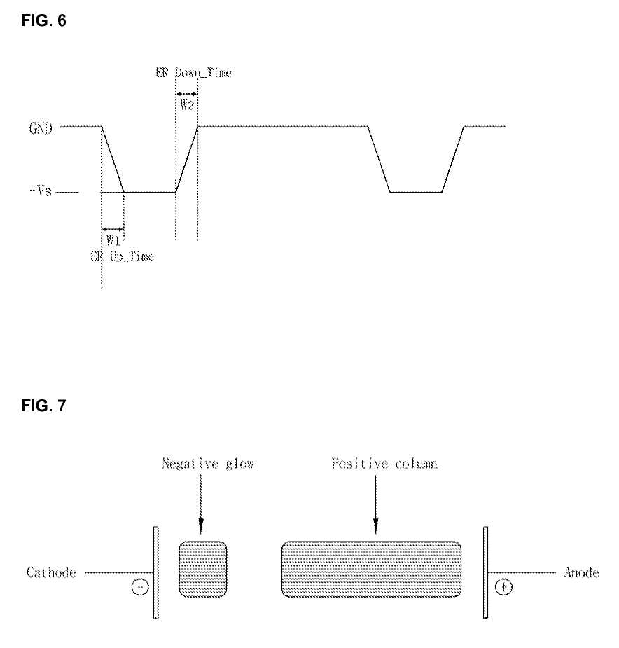

### DETAILED DESCRIPTION OF EMBODIMENTS

Hereafter, a plasma display apparatus and a driving method thereof of the present invention will be described in a more detailed manner with reference to the accompanying drawings.

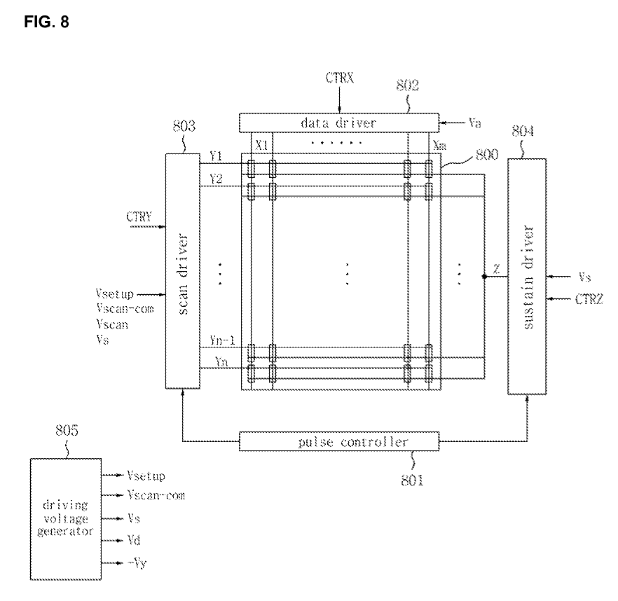

FIG. 8 is a view for illustrating a structure of a plasma display apparatus according to an embodiment of the present invention.

Referring to FIG. 8, the plasma display apparatus of the present invention comprises: a plasma display panel 800 displaying images by applying driving pulses to address electrodes X1 to Xm, scan electrodes Y1 to Yn, and a sustain electrode Z during the reset period, address period, and sustain period; a data driver 802 supplying data to the address electrodes X1 to Ym provided on the plasma display panel 800; a scan driver 803 driving the scan electrodes Y1 to Yn; a sustain driver 804 driving a common electrode, i.e. the sustain electrode Z; a pulse controller 801 controlling the scan driver 803 and sustain driver 804 when the plasma display panel is driven to thereby adjust the supply of reset pulses during the reset period and the supply of scan pulses during the address period and adjust the voltage and width of the sustain pulses during the sustain period; and a driving voltage generator 805 supplying driving voltages required for each driver 802, 803, 804.

The data driver 802 is supplied with data inverse gamma corrected and error diffused by an inverse gamma correction circuit and an error diffusion circuit, respectively, and then mapped to each sub-field by a sub-field mapping circuit. The inverse gamma correction circuit, error diffusion circuit, and sub-field mapping circuit all are not shown in drawings. The data driver 802 samples and latches data corresponding to a data timing control signal CTRX from the timing controller (not shown) and then supplies the data to the address electrodes X1 to Xm.

The scan driver 803 supplies reset pulses to the scan electrodes Y1 to Yn during the reset period and scan pulses to the scan electrodes Y1 to Yn during the address period under control of the pulse controller 801, and supplies negative sustain pulses to the scan electrodes Y1 to Yn during the sustain under control of the sustain pulse controller.

The sustain driver 804 supplies a bias voltage having a prescribed magnitude to the sustain electrode Z during the address period under control of the pulse controller 801, and the sustain driver 804 and scan driver 803 take turns in supplying negative sustain pulse −Vs to the sustain electrode Z during the sustain period and an erase pulse to the sustain electrode Z during the erase period.

The pulse controller 801 supplies a prescribed control signal to each driver 802, 803, 804 to control the operation timing and synchronization of the drivers 802, 803, 804 during the reset period, address period, sustain period, and erase period.

In particular, the present invention is characterized and makes a difference from the prior art in that the pulse controller 801 controls the scan driver 803 and sustain driver 804 and adjusts an energy supply time ER Up-Time and energy recovery time ER Down-Time of a negative sustain pulse supplied to one or more of the scan electrodes Y1 to Yn or sustain electrode Z during the sustain period.

Here, the slope of the sustain pulse is sharply adjusted so that the energy supply time ER Up-Time and energy recovery time ER Down-Time of the negative sustain pulse supplied to one or more of the scan electrodes or sustain electrodes each have less than 300 ns. That is, this provides an effect to enable a sustain discharge to occur without the increase of absolute value of the negative sustain voltage −Vs for causing the sustain discharge because a strong discharge can be occurred due to the increase of voltage variation rate per time. Furthermore, since the energy supply time ER Up-Time and energy recovery time ER Down-Time are shorten, time that one sustain pulse occupies is reduced and high speed driving can be performed. Therefore driving time can be saved.

In addition, the energy supply time ER Up-Time and energy recovery time ER Down-Time may be adjusted similarly, which enables driving devices for adjusting the energy supply time ER Up-Time and energy recovery time ER Down-Time to be integrally used. Therefore, manufacturing costs of parts for the plasma display apparatus can be saved.

And, the energy recovery time ER Down-Time may be adjusted to be longer than the energy supply time ER Up-Time. It is in charge of the energy supply time ER Up-Time to cause a sustain discharge to start, and therefore, if the energy supply time ER Up-Time is more shortened, then a sustain discharge can occur even without the increase of absolute value of the negative sustain voltage −Vs. On the other hand, making the energy recovery time ER Down-Time longer than the energy supply time ER Up-Time can provide an effect to raise the energy recovery efficiency.

In addition, the gap between the scan electrode and the sustain electrode may range from 100 μm to 400 μm or from 150 μm to 350 μm. When the gap between the scan electrode and the sustain electrode ranges from 100 μm to 400 μm, a positive column with the high emission efficiency can be used. Further, when the gap between the scan electrode and the sustain electrode ranges from 150 μm to 350 μm, the positive column can be used and also the size of the discharge cell can be reduced.

The afore-mentioned data control signal CTRX comprises a sampling clock for sampling data, a latch control signal, and a switch control signal for controlling ON/OFF time of an energy recovery circuit and a drive switch element. The scan control signal CTRY comprises a switch control signal for controlling ON/OFF time of an energy recovery circuit (not shown) and a driving switch element in the scan driver 803 and the sustain control signal CTRZ comprises a switch control signal for controlling ON/OFF time of an energy recovery circuit and a driving switch element in the sustain driver 804.

The drive voltage generator 805 generates a setup voltage Vsetup, a scan common voltage Vscan-com, a scan voltage −Vy, a sustain voltage Vs, a data voltage Vd, etc. The drive voltages can be varied depending on the composition of discharge gases or the construction of discharge cell.

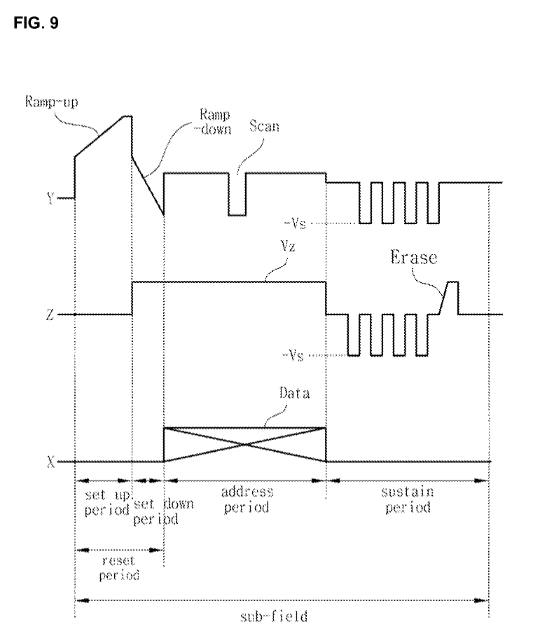

An operation of the plasma display apparatus shown in FIG. 8 according to the present invention will now be described clearly with reference to a driving method illustrated in FIG. 9.

FIG. 9 is a view illustrating an example of driving waveforms according to a negative sustain driving method of a plasma display panel of the present invention.

Referring to FIG. 9, the driving method of the plasma display panel according to the present invention is performed with a sub-field divided into a reset period for initializing all the cells, an address period for selecting cells to be discharged, a sustain period for maintaining the discharge of the selected cells, and an erase period for erasing wall charges within the discharged cells.

In the set up period of the reset period, all the scan electrodes are simultaneously applied with a rising ramp waveform Ramp-up. A weak dark discharge occurs within the discharge cells of the entire screen by this rising ramp waveform. Due to this set up discharge, positive wall charges are accumulated on the address electrodes and sustain electrodes and negative wall charges are accumulated on the scan electrodes.

A falling ramp waveform Ramp-down, which falls from a positive voltage being lower than the peak voltage of the rising ramp waveform to a specific voltage level below ground GND level voltage in the set down period after the rising ramp waveform was supplied, causes a weak erase discharge in the cells thereby to sufficiently erase wall charges excessively formed in the scan electrodes. This set down discharge allows wall charges to be evenly distributed within the cells so that an address discharge can occur stably.

In the address period, negative scan pulses are sequentially applied to the scan electrodes, and at the same time positive data pulses synchronized with the scan pulses are applied to the address electrodes. The voltage difference between the scan pulse and data pulse is added to the wall voltage generated in the reset period, thereby causing an address discharge to occur in the discharge cells applied with the data pulses. The wall charges are generated in the cells selected by the address discharge as many as a discharge can occur when the sustain voltage Vs is applied. A positive voltage Vz is supplied to the sustain electrodes so that unwanted discharges with the scan electrodes do not occur during at least one of the set down period or address period by decreasing the voltage difference between the sustain electrodes and the scan electrodes.

In the sustain period, a negative sustain pulse −Vs is applied alternately to the scan electrodes and sustain electrodes. The wall voltage within the cells selected by the address discharge are added to the sustain pulses, thereby causing sustain discharges, i.e., display discharges between the scan electrodes and the sustain electrodes whenever the sustain pulses are applied to the selected cells.

A voltage of an erase ramp waveform Ramp-ers having small pulse width and voltage level is supplied to the sustain electrodes in the erase period after the sustain discharge was completed, thereby erasing the wall charges residing within the discharge cells of the entire screen.

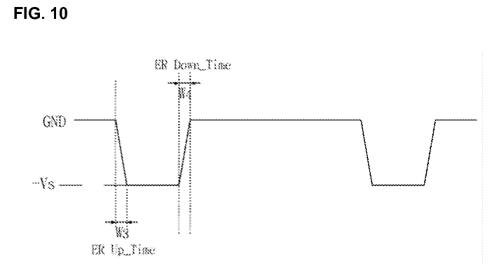

In particular, the driving method of the plasma display apparatus according to the present invention is characterized by the sustain period from the prior art, and a more detailed description of a sustain pulse applied during a sustain period is illustrated with reference to FIG. 10.

FIG. 10 is a view illustrating a negative sustain pulse applied during a sustain period among driving waveforms according to a negative sustain driving method of a plasma display panel of the present invention.

Referring to FIG. 10, the negative sustain driving method of the present invention is characterized in adjusting each of an energy supply time ER Up-Time and an energy recovery time ER Down-Time of a negative sustain pulse supplied to one or more of the scan electrodes or sustain electrodes during a sustain period.

Here, the slope of the sustain pulse is sharply adjusted so that the energy supply period ER Up-Time and energy recovery period ER Down-Time of the negative sustain pulse supplied to one or more of the scan electrodes or sustain electrodes each have less than 300 ns in each width W3, W4. That is, this provides an effect to enable a sustain discharge to occur without the increase of absolute value of the negative sustain voltage −Vs for causing the sustain discharge because a strong discharge can be occurred due to the increase of voltage variation rate per time. Furthermore, since the energy supply period ER Up-Time and energy recovery period ER Down-Time are shorten, time that one sustain pulse occupies is reduced and high speed driving can be performed. Therefore driving time can be saved.

In addition, the energy supply period ER Up-Time and energy recovery period ER Down-Time may be adjusted similarly, which enables driving devices for adjusting the energy supply period ER Up-Time and energy recovery period ER Down-Time to be integrally used. Therefore, manufacturing costs of parts for the plasma display apparatus can be saved.

And, the energy recovery period ER Down-Time may be adjusted to be longer than the energy supply period ER Up-Time. It is in charge of the energy supply period ER Up-Time to cause a sustain discharge to start, and therefore, if the energy supply period ER Up-Time is more shortened, then a sustain discharge can occur even without the increase of absolute value of the negative sustain voltage −Vs. On the other hand, making the energy recovery period ER Down-Time longer than the energy supply period ER Up-Time can provide an effect to raise the energy recovery efficiency.

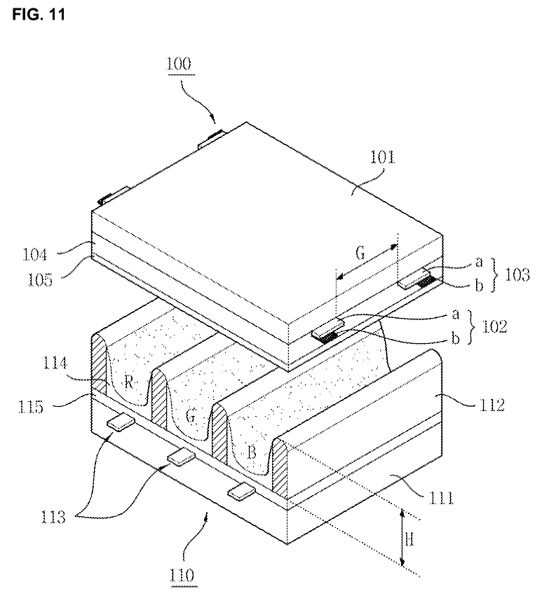

Referring to FIG. 11, the plasma display panel comprises a front panel 100 and a rear panel 110 which are coupled in parallel to be spaced from each other at a given distance therebetween. The front panel 100 comprises a front glass 101 being a display surface on which images are displayed, and the rear panel 110 comprises a rear glass 111 being a rear surface. Scan electrodes 102 and sustain electrodes 103 are formed in pairs on the front glass 101 to form a plurality of maintenance electrode pairs. A plurality of address electrodes 113 are arranged on the rear glass 111 to intersect the plurality of maintenance electrode pairs.

The front panel 100 comprises the scan electrode 102 and the sustain electrode 103, each comprising transparent electrodes (a) made of a transparent indium-tin-oxide (ITO) material and bus electrodes (b) made of a metal material. The scan electrode 102 and the sustain electrode 103 generate a mutual discharge therebetween in one discharge cell and maintain light-emission of the cell. The scan electrode 102 and the sustain electrode 103 are covered with one or more upper dielectric layers 104 for limiting a discharge current and providing insulation between the maintenance electrode pairs. A protective layer 105 with a deposit of MgO is formed on an upper surface of the upper dielectric layer 104 to facilitate discharge conditions.

A plurality of stripe-type (or well-type) barrier ribs 112 are formed in parallel on the rear panel 110 to form a plurality of discharge spaces, that is, a plurality of discharge cells. In addition, the plurality of address electrodes 113 are arranged in parallel with the barrier ribs 112 to perform an address discharge to thereby cause the inert gas in the discharge cells to generate vacuum ultraviolet rays. On the upper surface of the rear panel 110 there are applied a red (R), a green (G), and a blue (B) phosphors to emits visible light for displaying images when a sustain discharge occurs. A lower dielectric layer 115 is formed between the address electrodes 113 and the phosphors 114 to protect the address electrodes 113.

The electrode structure of the scan electrode 102 and the sustain electrode 103 is a long-gap structure. The gap G between the scan electrode 102 and the sustain electrode 103 is more than the height H of the barrier rib 112. The gap G between the scan electrode 102 and the sustain electrode 103 may equal to a gap G between the transparent electrodes 102a and 103a. The gap G between the scan electrode 102 and the sustain electrode 103 may range from 100 μm to 400 μm or from 150 μm to 350 μm.

As mentioned above, the present invention can drive a plasma display panel without the increase of application voltage by adjusting an energy supply time ER Up-Time and an energy recovery time ER Down-Time of a negative sustain pulse applied to the plasma display panel during a sustain period.

Furthermore, the present invention shortens the energy supply period ER Up-Time and energy recovery period ER Down-Time, which reduces time that one sustain pulse occupies and enables high speed driving, thereby being capable of saving driving time.

The foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures. Moreover, unless the term “means” is explicitly recited in a limitation of the claims, such limitation is not intended to be interpreted under 35 USC 112(6).

What is claimed is:

1. A plasma display apparatus comprising:
a plasma display panel comprising a plurality of scan electrodes and sustain electrodes;
a driver driving the plurality of scan electrodes and sustain electrodes; and
a negative sustain pulse controller controlling the driver and adjusting each of an energy supply time and an energy recovery time of a negative sustain pulse supplied to one or more of the scan electrodes or sustain electrodes during a sustain period.

2. The plasma display apparatus of claim 1, wherein the energy supply time and the energy recovery time of the negative sustain pulse supplied to one or more of the scan electrodes or sustain electrodes each are less than 300 ns.

3. The plasma display apparatus of claim 2, wherein the energy supply time and the energy recovery time are the same substantially.

4. The plasma display apparatus of claim 2, wherein the energy recovery time is longer than the energy supply time.

5. The plasma display apparatus of claim 2, wherein a gap between the scan electrode and the sustain electrode ranges from 100 μm to 400 μm.

6. The plasma display apparatus of claim 5, wherein the gap between the scan electrode and the sustain electrode ranges from 150 μm to 350 μm.

7. A driving method of a plasma display panel comprising a plurality of scan electrodes and sustain electrodes,
wherein an energy supply time and an energy recovery time of a negative sustain pulse supplied to one or more of the scan electrodes or sustain electrodes during a sustain period of a plurality of subfields can be respectively adjusted.

8. The driving method of claim 7, wherein the energy supply time ER Up-Time and the energy recovery time ER Down-Time of the negative sustain pulse supplied to one or more of the scan electrodes or sustain electrodes each are less than 300 ns.

9. The driving method of claim 8, wherein the energy supply time and the energy recovery time are substantially the same.

10. The driving method of claim 8, wherein the energy recovery time is longer than the energy supply time.

11. The driving method of claim 8, wherein a gap between the scan electrode and the sustain electrode ranges from 100 μm to 400 μm.

12. The driving method of claim 8, wherein a gap between the scan electrode and the sustain electrode ranges from 150 μm to 350 μm.

13. A plasma display apparatus comprising:
a plasma display panel comprising a scan electrode, a sustain electrode, and a barrier rib, wherein the height of the barrier rib is less than a gap between the scan electrode and the sustain electrode;
a driver driving the scan electrode and the sustain electrode; and
a negative sustain pulse controller controlling the driver and adjusting each of an energy supply time and an energy recovery time of a negative sustain pulse supplied to one or more of the scan electrode or the sustain electrode during a sustain period.

14. The driving method of claim 13, wherein the scan electrode and the sustain electrode each include a transparent electrode, and
the gap between the scan electrode and the sustain electrode is substantially equal to a gap betwene the transparent electrode of the scan electrode and the transparent electrode of the sustain electrode.

15. The driving method of claim 13, wherein a gap between the scan electrode and the sustain electrode ranges from 100 μm to 400 μm.

16. The driving method of claim 13, wherein a gap between the scan electrode and the sustain electrode ranges from 150 μm to 350 μm.
